(19) United States
(12) Patent Application Publication
(10) Pub. No.: US 2017/0156381 A1
(43) Pub. Date: Jun. 8, 2017

(54) MARGIE'S SOUTHERN COMFORT FOODS

(71) Applicants: Margie Gillus Horton, Upper Marlboro, MD (US); Gerald Eric Horton, Upper Marlboro, MD (US)

(72) Inventors: Margie Gillus Horton, Upper Marlboro, MD (US); Gerald Eric Horton, Upper Marlboro, MD (US)

(21) Appl. No.: 15/436,861

(22) Filed: Feb. 20, 2017

Related U.S. Application Data
(63) Continuation-in-part of application No. 14/870,826, filed on Sep. 30, 2015, now abandoned.

(51) Int. Cl. A23L 1/16

(52) U.S. Cl. CPC A23L 7/109

(57) ABSTRACT

A method comprising steps: (a) heating a quantity of water to a boil, wherein the quantity of water contains salt; (b) adding a plurality of elbow macaroni noodles to the quantity of water; (c) draining the quantity of water after a first predetermined amount of time to obtain cooked elbow macaroni noodles; (d) adding butter to the cooked elbow macaroni noodles, wherein the butter is melted and mixed with the cooked elbow macaroni noodles; (e) adding and mixing pepper to the cooked elbow macaroni noodles; (f) cracking two extra large eggs and mixing to the cooked elbow macaroni noodles; (g) adding and mixing heavy whipping cream to the cooked elbow macaroni noodles; (h) adding a cheese blend consisting of 25% extra sharp cheddar cheese, 25% white cheddar cheese, and 50% soft yellow processed cheese, wherein the cheese blend is melted and mixed to the cooked elbow macaroni noodles; and (i) baking the cooked elbow macaroni noodles mixture at a predetermined temperature for a second predetermined amount of time.

### CROSS-REFERENCE TO RELATED APPLICATIONS

The present application is a Continuation-in-Part application, which claims priority to U.S. patent application Ser. No. 14/870,826, filed on Sep. 30, 2015 entitled “Margie's Southern Comfort Foods”, the disclosure of which is hereby incorporated in its entirety by reference.

### BACKGROUND OF THE INVENTION

Field of the Invention

The present invention generally relates to a novel and advantageous food product and the method to prepare the food product, more particularly, the invention relates to macaroni and cheese based food product.

Background of the Invention

Macaroni is a dry form of pasta and is an Italian cuisine which has become quite popular throughout the world. It is quick and simple to make. Since invented, it is prepared in variety of forms wherein different ingredient including the species is modified to get a different taste. Marconi with cheese is particularly popular for its cheesy and soft texture. Cheeses are available in different varieties having their unique taste. The taste and texture of cheese also varies depending upon the method in preparation of cheese. Thus beside other ingredient, the choice of a particular cheese is quite important for a recipe that is appealing to olfactory and taste senses and which is liked by most of the people.

Thus a need is appreciated for a food product that has unique combination of ingredients and which is commercial advantageous.

### BRIEF SUMMARY OF THE INVENTION

In one embodiment of the present invention, a food product is provide, comprising: (a) cooked elbow macaroni noodles prepared by boiling the macaroni noodles in water containing salt, wherein the cooked elbow macaroni noodles has a dry weight of 16 ounces; and (b) a sauce consisting of: extra sharp cheddar cheese in a concentration of 11.50% by weight; white cheddar cheese in a concentration of 11.50% by weight; soft yellow processed cheese in a concentration of 23.00% by weight; heavy whipping cream in a concentration of 45.00% by weight; egg including egg yolk and egg white in a concentration of 6.50% by weight; butter in a concentration of 1.40% by weight; salt in a concentration of 0.86% by weight; pepper in a concentration of 0.03% by weight.

In one embodiment, the white cheddar cheese is a Vermont white cheddar cheese.

In another aspect of the invention, a method is provided, comprising steps: (a) heating a quantity of water to a boil, wherein the quantity of water contains salt; (b) adding a plurality of elbow macaroni noodles to the quantity of water; (c) draining the quantity of water after a first predetermined amount of time to obtain cooked elbow macaroni noodles; (d) adding butter to the cooked elbow macaroni noodles, wherein the butter is melted and mixed with the cooked elbow macaroni noodles; (e) adding and mixing pepper to the cooked elbow macaroni noodles; (0 cracking two extra-large eggs and mixing to the cooked elbow macaroni noodles; (g) adding and mixing heavy whipping cream to the cooked elbow macaroni noodles; (h) adding a cheese blend consisting of 25% extra sharp cheddar cheese, 25% white cheddar cheese, and 50% soft yellow processed cheese, wherein the cheese blend is melted and mixed to the cooked elbow macaroni noodles; and (i) baking the cooked elbow macaroni noodles mixture at a predetermined temperature for a second predetermined amount of time.

In one embodiment, in step (b), the plurality of elbow macaroni noodles has a dry weight of 16.00 ounces. In another embodiment, in step (c), the first predetermined time is 20 minutes. In one embodiment, in step (d), the butter has a weight of 1.00 ounce. In one embodiment, in step (e), the pepper has a weight of 0.02 ounces. In another embodiment, in step (g), the heavy whipping cream has a weight of 31.27 ounces. In one embodiment, in step (h), the extra sharp cheddar cheese has a weight of 8.00 ounces, the white cheddar cheese has a weight of 8.00 ounces, and the soft yellow processed cheese has a weight of 16.00 ounces. In yet another embodiment, in step (i), the predetermined temperature is 300 degrees Fahrenheit and the second predetermined amount of time is 90 minutes.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 shows an exemplary perspective view of Margie's southern comfort food prepared according to embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be understood that the invention is not limited in its application to the details of construction and the arrangements of the components set forth in the following description. The invention is capable of other embodiments and of being practiced and carried out in various ways. Also it is to be understood that the phraseology and terminology employed herein are for the purpose of description and should not be regarded as limiting.

The present invention, therefore, has as its principal object to provide novel and advantageous food product. Another object of the invention is to provide a method of preparing the food product. Still another object of invention is that the food product is appealing to olfactory and taste senses. Still another object of current invention is that the food product has nutritional value. Yet another object of current invention is the food product has a commercial advantage.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Certain embodiments of current invention, but are not limited, is to provide a novel and advantageous food product comprising elbow macaroni noodles, extra sharp cheese, white cheddar cheese, soft yellow processed cheese, heavy whipping cream, eggs, butter, salt and pepper.

In another embodiment the present invention provides a method to prepare the food product comprising boiling of elbow macaroni noodle in water containing salt and draining the water after macaroni is cooked; adding butter and pepper to cooked noodles and heating to melt the butter; adding egg yolk and egg white followed by whipping cream; adding extra sharp cheddar cheese, the white cheddar cheese, and then the soft yellow processed cheese; mixing all the ingredients and then baking in a preheated oven till the food product is slightly golden brown.

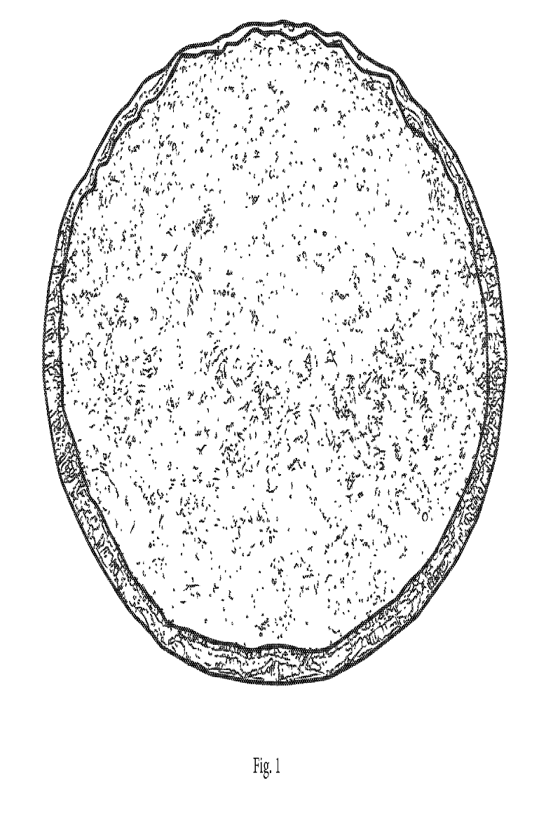

Referring to FIG. 1, the present invention provides a macaroni and cheese based food product. A unique combination of ingredients creates a recipe that has an exceptional pleasing taste and odor which provides commercial advantage to the food product. The food product includes ingredients selected from elbow macaroni noodles, extra sharp cheese, white cheddar cheese, soft yellow processed cheese, heavy whipping cream, eggs, butter, salt and pepper.

In one embodiment, the extra sharp cheddar cheese is a Cracker Barrel extra sharp cheese and the white cheddar cheese is a Cracker Barrel Vermont white cheese, the Cracker Barrel extra sharp cheese and the Cracker Barrel Vermont white cheese are brand names of dairy cheddar cheese available from Kraft Foods®. These sharp cheeses are particularly useful for current invention. In these varieties of cheddar cheeses, cream is combined for extra smoothness with a unique aging process for bold sharpness. Cracker Barrel extra sharp cheese has a milky and cheesy aroma, easy to slice and the flavor resembles cheddar, dairy sweet, fruity, with a rich and balanced creaminess. In contrast, the Cracker Barrel Vermont white cheese has cheddar, fruity, and sulfur aroma, and is hard to slice. It appears slightly dry and crumbly and the flavor resembles complex, bold cheddar background, with a unique sulfur character. Preferably both are used in the food product that imparts a unique flavor to the food product.

In one embodiment, the soft yellow processed cheese is a Velveeta cheese, wherein Velveeta is brand name of another processed soft American cheese available from Kraft Foods®. The Velveeta cheese has a softer and smoother texture than normal cheese. When melted, the Velveeta type soft yellow processed cheese maintains fully integrated, having an even and clump-free liquid texture.

Heavy whipping cream also known as heavy cream is whipping cream with a milk fat content of 36 percent or more and is preferable for use in current invention. Macaroni of curved shaped also called elbow macaroni are preferably used in the current invention although other macaroni types could also be used.

Salt, pepper and butter add to the flavor of the food product, although these could be omitted or their quantity could be varied according to the taste perception of an individual.

### BEST MODE OF CARRYING OUT THE INVENTION

Ingredients: 16 oz. Elbow macaroni noodles; 8 oz. block of extra sharp cheddar cheese; 8 oz. block of Vermont white cheddar cheese; 16 oz. package soft yellow American processed cheese; 1 qt. heavy whipping cream; 2 extra-large eggs; 1 oz. butter; Tablespoon of salt; and a dash of pepper.

The tools needed for the preparation of food product includes a large pot, a baking pan, cooking utensils, a stove top and oven.

Method to prepare the food product: a tablespoon of salt is added to boiling water in pot on stove top. To the boiling water elbow macaroni noodles are added and cooked for 20 minutes. After the noodles are cooked, the water is drained and the pot is again placed on the stove under a low heat setting. Next, butter and cheese are added to the pot, the heat setting must be sufficient to melt the butter and cheese. Next, the noodles are then added to the butter and cheese with pepper added during mixing. The ingredients are stirred till the butter melts and mixes with other ingredients. Then, 2 extra-large eggs are added and mixed thoroughly. Next, the heavy whipping cream is added into the pot while stirring the mixture. Next, Velveeta cheese is added to the mixture and mixed until the Velveeta cheese melts. Similarly, Cracker Barrel extra sharp cheese is then added and melted while mixing. In a similar way, Cracker Barrel Vermont white cheese is also added and mixed until melted. Once all of the ingredients are mixed well, the mixture is poured into a medium size baking pan. The mixture is then placed in a preheated oven and baked at 300 degrees Fahrenheit for 1 hour and 30 minutes or until slightly golden brown. The food product then could be served, as illustrated in the FIG. 1.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as :limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A food product comprising:
(a) cooked elbow macaroni noodles prepared by boiling the macaroni noodles in water containing salt, wherein the cooked elbow macaroni noodles has a dry weight of 16 ounces; and
(b) a sauce consisting of:
extra sharp cheddar cheese in a concentration of 11.50% by weight;
white cheddar cheese in a concentration of 11.50% by weight;
soft yellow processed cheese in a concentration of 23.00% by weight;
heavy whipping cream in a concentration of 45.00% by weight;
egg including egg yolk and egg white in a concentration of 6.50% by weight;
butter in a concentration of 1.40% by weight;
salt in a concentration of 0.86% by weight;
pepper in a concentration of 0.03% by weight.

2. The food product of claim 1, wherein the white cheddar cheese is a Vermont white cheddar cheese.

3. A method comprising steps:
(a) heating a quantity of water to a boil, wherein the quantity of water contains salt;
(b) adding a plurality of elbow macaroni noodles to the quantity of water;
(c) draining the quantity of water after a first predetermined amount of time to obtain cooked elbow macaroni noodles;
(d) adding butter to the cooked elbow macaroni noodles, wherein the butter is melted and mixed with the cooked elbow macaroni noodles;
(e) adding and mixing pepper to the cooked elbow macaroni noodles;
(f) cracking two extra large eggs and mixing to the cooked elbow macaroni noodles;
(g) adding and mixing heavy whipping cream to the cooked elbow macaroni noodles;
(h) adding a cheese blend consisting of 25% extra sharp cheddar cheese, 25% white cheddar cheese, and 50% soft yellow processed cheese, wherein the cheese blend is melted and mixed to the cooked elbow macaroni noodles; and
(i) baking the cooked elbow macaroni noodles mixture at a predetermined temperature for a second predetermined amount of time.

4. The method of claim 3, wherein in step (b), the plurality of elbow macaroni noodles has a dry weight of 16.00 ounces.

5. The method of claim 3, wherein in step (c), the first predetermined amount of time is 20 minutes.

5. The method of claim 3, wherein in step (d), the butter has a weight of 1.00 ounce.

6. The method of claim 3, wherein in step(e). the pepper has a weight of 0.02 ounces.

7. The method of claim 3, wherein in step (g), the heavy whipping cream has a weight of 31.27 ounces.

8. The method of claim 3, wherein in step (h), the extra sharp cheddar cheese has a weight of 8.00 ounces, the white cheddar cheese has a weight of 8.00 ounces, and the soft yellow processed cheese has a weight of 16.00 ounces.

9. The method of claim 3, wherein in step (i), the predetermined temperature is 300 degrees Fahrenheit and the second predetermined amount of time is 90 minutes.
